(19) United States
(12) Patent Application Publication
(10) Pub. No.: US 2014/0142274 A1
(43) Pub. Date: May 22, 2014

(54) SOLID PARTICLES, CONTAINING LACTAM, ACTIVATOR, AND CATALYST, METHOD FOR PRODUCING SAID SOLID PARTICLES, AND USE OF SAID SOLID PARTICLES

(71) Applicants: Philippe Desbois, Edingen-Neckarhausen (DE); Silke Biedasek, Mannheim (DE); Andreas Wollny, Freinsheim (DE)

(72) Inventors: Philippe Desbois, Edingen-Neckarhausen (DE); Silke Biedasek, Mannheim (DE); Andreas Wollny, Freinsheim (DE)

(73) Assignee: BASF SE, Ludwigshafen (DE)

(21) Appl. No.: 14/131,088

(22) PCT Filed: Jul. 2, 2012
(86) PCT No.: PCT/EP12/62792

§ 371 Date: Jan. 6, 2014

(30) Foreign Application Priority Data
Jul. 5, 2011 (EP) 11172731.9
Aug. 9, 2011 (EP) 11176950.1

(51) Int. Cl. C08G 69/20

(52) U.S. Cl. CPC C08G 69/20
USPC 528/315; 528/323; 528/312; 528/316

(57) ABSTRACT

The present invention relates to solid particles which comprise at least one lactam, and also at least one activator, and at least one catalyst, to a process for the production of these, and also to the use of these for the production of polyamide, and to a process for the production of polyamide.

The present invention relates to solid particles which comprise at least one lactam, and also at least one activator, and at least one catalyst, to a process for the production of these, and also to the use of these for the production of polyamide, and to a process for the production of polyamide.

In recent years, there has been increasing use of polyamide moldings, in particular fiber-reinforced polyamide moldings, as materials to replace metallic materials, for example in automobile construction; they can replace not only powertrain components but also bodywork components made of metal. It is often advantageous here during the production of a polyamide molding to charge a monomer melt, instead of a polymer melt, to the mold. The lower viscosity can by way of example achieve higher fill levels in the case of a filled or fiber-reinforced molding.

It is also advantageous to charge monomer powder directly to the mold, or to coat the mold directly with monomer powder, and then to initiate the polymerization reaction in situ. This method can also save energy in the process, since all that is required is generally heating to a temperature above the melting point of the monomer, rather than above the melting point of the polymer, and the melting point of a monomer is generally lower than the melting point of a polymer produced therefrom.

The process for the production of polyamide via activated anionic lactam polymerization is in principle known.

Lactams, such as caprolactam, lauryllactam, piperidone, and pyrrolidone, and also lactones, such as caprolactone, can be polymerized in a base-catalyzed anionic polymerization reaction with ring-opening. For this, a melt composed of lactam and/or lactone, comprising an alkaline catalyst and comprising what is known as an activator (or cocatalyst or initiator) is generally polymerized at temperatures of about 150° C.

By way of example, DE-A 14 20 241 describes an anionic polymerization reaction of lactams in the presence of potassium hydroxide as catalyst and with use of 1,6-bis(N,N-dibutylureido)hexane as activator. The activated anionic lactam polymerization reaction with use of sodium caprolactam is described by way of example in Polyamide, Kunststoff Handbuch [Polyamides, Plastics handbook], vol. 3/4, ISBN 3-446-16486-3, 1998, Carl Hanser Verlag, pp. 49-52 and Macromolecules, vol. 32, no. 23 (1993), p. 7726.

As previously described in the prior art, the anionic polymerization reaction of lactams and of lactones can take place by a reactive molding process or by a reaction injection molding process, where the catalyst and further additives are added to the lactam melt and/or lactone melt during the process.

Since the anionic polymerization reaction of lactams and lactones has to take place with exclusion of oxygen, carbon dioxide, and water in order to avoid premature termination of the polymerization reaction, the conduct of a polymerization reaction by a reactive molding process or reaction injection molding process implies considerable technical cost.

It would therefore be advantageous in terms of process economics if the production of polyamide moldings could use a composition which itself comprises the lactam monomer and/or lactone monomer, the catalyst, and the activator and also optionally further additives, and which could be polymerized directly in the mold or on a support, e.g. a textile support, for example via temperature increase. It would be advantageous to obtain said activated lactam (or lactone), for example caprolactam, directly in the form of particle or, respectively, powder solid at room temperature.

In order to facilitate draw-off, transport, and storage, a melt of a component required for the activated anionic caprolactam polymerization reaction can be cooled to produce granules, flakes, or prills, and prills here have advantages over granules or flakes because they have lower dust content and better flow properties.

It is known that solid particles can be produced, for example those known as prills, where these comprise only one raw material for the production of a polymer, an example being bisphenol A for the production of a polycarbonate.

DE 199 53 301 A1 moreover describes the production of solid particles which comprise dihydroxy compounds and carbonic ester, and also the use of said particles for the production of polycarbonate via transesterification.

Prills can by way of example be produced by introducing a molten component at the top of a prilling tower by way of a die plate with a large number of nozzles; a coolant gas conducted in a circuit is introduced into the same prilling tower, whereupon the prills cooled to about room temperature are collected at the base of the prilling tower, and drawn off.

The expression “prilling tower” denotes an apparatus within which liquid components can be converted to droplets or to spray, and can then be hardened via cooling.

Separate storage and separate transport of the starting materials for the process for the production of polyamide via activated anionic lactam polymerization imply high logistic costs. The separate introduction of the two raw materials into the process for the production of polyamide via activated anionic lactam polymerization is likewise attended by high apparatus cost.

The required production of an inert atmosphere for the anionic lactam polymerization reaction is also often very complicated.

Other factors increasing the difficulty of processing of the product are viscosity and brittleness, both of which are mostly high.

The present invention was therefore based on the object of providing a process which does not have the disadvantages of the processes known from the prior art and which can produce polyamide via an activated anionic lactam polymerization reaction.

The intention was to facilitate further processing on the customer's premises; a further intention was to provide good flowability.

A further object of the present invention consists in providing a process which can produce a monomer composition that is solid at room temperature and which comprises lactams, and which can be polymerized per se without further addition of catalysts and/or activators.

Another object of the present invention consisted in providing a process which can produce a polyamide molding and which can be conducted easily and at low cost with use of familiar, simple shaping processes, and which can be used to obtain polyamide moldings which have high quality and which have low content of residual monomer.

Another object was to provide a process which can produce a monomer composition that is solid at room temperature and that comprises lactams, and that can be used in coating processes, in particular powder coating processes.

The object of the invention is achieved via a process as defined in the claims, in particular via a process for the production of polyamide via an activated anionic lactam polymerization reaction, where the lactams, the activator, and the catalyst are introduced to the process in the form of solid, preferably spherical, particles which comprise not only lactams but also the catalyst and the activator.

Accordingly, the present invention provides a solid particle (P) which comprises from 50 to 99.7 parts by weight, preferably from 70 to 98 parts by weight, of at least one lactam (L), from 0.2 to 8 parts by weight, preferably from 2.4 to 5.6 parts by weight, of at least on activator (A), and from 0.1 to 3.6 parts by weight, preferably from 0.65 to 3 parts by weight, of at least one catalyst (K).

It is possible here to use other raw materials for the process of the invention, alongside the solid particles mentioned.

For the purposes of the present disclosure, the expression “solid particles” means a particle which is solid at room temperature. The particle of the invention is preferably still also solid at higher temperatures, e.g. at 50° C.

In one preferred embodiment, the at least one lactam (L) has been selected from the group comprising caprolactam, piperidone, pyrrolidone, lauryllactam, and mixtures of these, particular preference being given to caprolactam.

The average diameter of the solid particles is generally from 1 to 2000 μm, preferably from 10 to 1000 μm, particularly preferably from 50 to 500 μm, very particularly preferably from 100 to 200 μm, where the diameter can be determined via light scattering and means the volume-average diameter.

The present invention further provides the use of solid particles (P) of the invention for the production of polyamide.

The present invention also provides a process for the production of solid particles (P) of the invention, which comprises cooling a mixture which comprises from 50 to 99.7 parts by weight, preferably from 70 to 98 parts by weight, particularly preferably from 80 to 95 parts by weight, of at least one lactam (L), from 0.2 to 16 parts by weight, preferably from 2.4 to 8 parts by weight, particularly preferably from 3.2 to 5.6 parts by weight, of at least one activator (A), and from 0.1 to 5.4 parts by weight, preferably from 0.54 to 3.6 parts by weight, particularly preferably from 0.64 to 3 parts by weight, of at least one catalyst (K).

In one preferred embodiment of the process of the invention, the location of the activator used and/or of the catalyst used is in a solution, for example in a solution which also comprises lactam, e.g. caprolactam.

In one particularly preferred embodiment, the activator comprises hexamethylene diisocyanate (HDI) in caprolactam, e.g. 80% by weight of HDI in caprolactam. It is also particularly preferable to use a catalyst comprising sodium caprolactamate in caprolactam, e.g. 18% by weight of sodium caprolactamate in caprolactam.

In another preferred embodiment, the process for the production of solid particles (P) of the invention comprises the following steps:
mixing, preferably continuous mixing, of components (L), (K), and (A) and optionally of further components, at a temperature in the range from the melting point of the highest-melting-point lactam monomer comprised in the mixture to 50° C. above the melting point of the highest-melting-point lactam monomer comprised in the mixture;
conversion, preferably continuous conversion, of the mixture to droplet form;
cooling of the droplet obtained in the preceding step to a temperature in the range from 100° C. below the melting point of the mixture to 10° C., preferably 30° C., below the melting point of the mixture;
optional granulation of the cooled mixture.

In one preferred embodiment, the entire process of the invention is continuous. The conversion in the reaction in the process of the invention prior to conversion to droplet form is preferably from 0 to 50%, particularly preferably from 0 to 30%.

As described in the prior art, in particular if an activator is added (e.g. an isocyanate, an acyl halide, or anhydride), the anionic polymerization reaction of lactams takes place very rapidly (high-speed polymerization) and even at very low temperatures close to the melting point of the lactam used.

Surprisingly, it has now been found possible to produce stable monomer compositions which are solid at room temperature and which comprise not only the lactam monomer but also an initiator and a catalyst. Said solid monomer compositions do not polymerize below the melting point of the monomer, and are therefore initially stable with respect to a polymerization reaction, at least if the process for the production of solid particles (P) is conducted in such a way that during the process of the invention the lactam crystallizes rapidly, e.g. in one preferred embodiment of the invention within a period in the range from one millisecond to one minute.

The monomer compositions that are solid at room temperature can be stored for a number of months and can be used at a later juncture for the production of a polyamide. Simple processes can be used for the polymerization reaction of this type of monomer composition, an example being injection molding or extrusion, generally at temperatures in the range from 100 to 200° C.

The monomer compositions of the invention which are solid at room temperature can comprise a certain proportion of polymer, but preferably comprise less than 50% by weight of polymer, based on the total weight of the polymer and of the monomer. It is particularly preferable that the monomer compositions of the invention which are solid at room temperature comprise less than 30% by weight of polymer, based on the total weight of the polymer and of the monomer.

The monomer composition described which is solid at room temperature is a valuable intermediate product which per se can be stored, transported, and handled, for example in the form of powder, granules, or capsules, in particular in the form of a powder. This ready-mixed solid monomer composition features easy handling.

There is moreover no need for any complicated reactive polymerization process comprising two components, for example RTM (Reaction Transfer Molding) or RIM (Reaction Injection Molding).

It is generally advantageous to minimize the amounts of contaminants, e.g. water, carbon dioxide, and oxygen. All of the components used should therefore in particular be dry and free from oxygen and carbon dioxide. It is preferable that the mixing of the starting components (and optionally of further components) takes place under inert gas (e.g. under nitrogen). In particular, the process steps of the invention are carried out with substantial exclusion of oxygen, carbon dioxide, and water.

The mixing of the components can take place in a batchwise or continuous process, in apparatuses which are suitable and known to the person skilled in the art. By way of example, the mixing of the components can take place continuously and/or batchwise in a stirred tank. By way of example, the mixing of the components can take place continuously in an extruder.

After the mixing of the components, it is preferable that cooling of the mixture takes place with maximum rapidity. In particular, the resultant mixture is cooled to a temperature in the range from 100° C. below the melting point of the mixture to 10° C., preferably 30° C., below the melting point of the mixture within a period in the range from one millisecond to ten minutes, preferably in the range from one millisecond to five minutes, particularly preferably in the range from one millisecond to one minute, very particularly preferably in the range from one millisecond to ten seconds. In particular, the cooling of the mixture obtained in step a) can take place via a stream of cold gas (e.g. a stream of nitrogen gas at 0° C.) or what is known as a “cold-disk process”.

Particularly suitable lactams are caprolactam, piperidone, pyrrolidone, lauryllactam, and mixtures of these, preference being given to caprolactam, lauryllactam and mixtures of these. It is particularly preferably to use caprolactam or lauryllactam as monomer (M).

Another possibility moreover is to use a mixture of lactam and lactone instead of a lactam as monomer. Examples of lactones that can be used are caprolactone and butyrolactone. The amount of lactone as comonomer here should not exceed 40% by weight, based on the entire monomer. It is preferable that the proportion of lactone as comonomer does not exceed 30% by weight, particularly preferably does not exceed 20% by weight, based on the entire monomer.

One preferred embodiment of the invention uses exclusively lactams as monomers (M).

In particular, lactam (L) used comprises at least one monomer selected from the group consisting of caprolactam, piperidone, pyrrolidone, and lauryllactam.

The process of the invention preferably uses a catalyst (K) which is a familiar catalyst for the anionic polymerization reaction. For the purposes of the present invention, a catalyst for the anionic polymerization reaction is a compound which permits formation of lactam anions. The lactam anions per se can also function as catalyst.

Catalysts of this type are known by way of example from Polyamide, Kunststoffhandbuch [Polyamides, Plastics handbook], 1998, Karl Hanser Verlag. For the purposes of the present invention it is preferable to use a catalyst (K) selected from the group consisting of sodium caprolactamate, potassium caprolactamate, magnesium bromide caprolactamate, magnesium chloride caprolactamate, magnesium biscaprolactamate, sodium hydride, sodium, sodium hydroxide, sodium methanolate, sodium ethanolate, sodium propanolate, sodium butanolate, potassium hydride, potassium, potassium hydroxide, potassium methanolate, potassium ethanolate, potassium propanolate, potassium butanolate, and mixtures of these, preferably consisting of sodium caprolactamate, potassium caprolactamate, magnesium bromide caprolactamate, magnesium chloride caprolactamate, magnesium biscaprolactamate, sodium hydride, sodium, sodium hydroxide, sodium ethanolate, sodium methanolate, sodium propanolate, sodium butanolate, potassium hydride, potassium, potassium hydroxide, potassium methanolate, potassium ethanolate, potassium propanolate, potassium butanolate, and mixtures of these.

It is particularly preferable to use a catalyst (K) selected from the group consisting of sodium hydride, sodium, and sodium caprolactamate; particular preference is given to sodium caprolactamate and/or to a solution of sodium caprolactamate in caprolactam (e.g. Bruggolen (BASF, DE) C100; 18% by weight of sodium caprolactamate in caprolactamate).

The molar ratio of lactam (L) to catalyst (K) can be varied widely, but is generally from 1:1 to 10 000:1, preferably from 5:1 to 1000:1, particularly preferably from 1:1 to 500:1.

The particle (P) which is solid at room temperature and which is produced by the process of the invention comprises at least one activator (A) for the anionic polymerization reaction.

For the purposes of this invention, an activator (A) for the anionic polymerization reaction is a lactam N-substituted by electrophilic moieties (e.g. an acyllactam).

An activator can also be a precursor of these activated N-substituted lactams, where this precursor forms in situ, together with the lactam (L), an activated lactam. The number of growing chains depends on the amount of activator. Compounds generally suitable as activator (A) are isocyanates, anhydrides, and acyl halides, and reaction products of these with the lactam monomer.

Suitable activators (A) are inter alia aliphatic diisocyanates, such as butylene diisocyanate, hexamethylene diisocyanate, octamethylene diisocyanate, decamethylene diisocyanate, undodecamethylene diisocyanate, dodecamethylene diisocyanate, 4,4′-methylenebis(cyclohexyl isocyanate), isophorone diisocyanate, aromatic diisocyanates, such as tolyl diisocyanate, methylenebis(phenyl) 4,4′-isocyanate, or polyisocyanates (e.g. isocyanates of hexamethylene diisocyanate; Basonat HI 100/BASF SE), and allophanates (e.g. ethyl allophanate). In particular, mixtures of the compounds mentioned can be used as activator (A).

Other suitable activators (A) are aliphatic diacyl halides, such as butylenedioyl chloride, butylenedioyl bromide, hexamethylenedioyl chloride, hexamethylenedioyl bromide, octamethylenedioyl chloride, octamethylenedioyl bromide, decamethylenedioyl chloride, decamethylenedioyl bromide, dodecamethylenedioyl chloride, dodecamethylenedioyl bromide, 4,4′-methylenebis(cyclohexyloyl chloride), 4,4′-methylenebis(cyclohexyloyl bromide), isophoronedioyl chloride, isophoronedioyl bromide; and also aromatic diacyl halides, such as tolylmethylenedioyl chloride, 4,4′-methylenebis(phenyl) acyl chloride, and 4,4′-methylenebis(phenyl) acyl bromide. In particular, mixtures of the compound mentioned can be used as activator (A).

Particular preference is given to a process which comprises using, as activator (A), at least one compound selected from the group consisting of aliphatic diisocyanates, aromatic diisocyanates, polyisocyanates, aliphatic diacyl halides, and aromatic diacyl halides.

In one preferred embodiment, activator (A) used comprises at least one compound selected from the group comprising hexamethylene diisocyanate, isophorone diisocyanate, hexamethylenedioyl bromide, hexamethylenedioyl chloride, and mixtures of these; it is particularly preferable to use hexamethylene diisocyanate.

The molar ratio of monomer (M) to activator (A) can vary widely, and is generally from 1:1 to 10 000:1, preferably from 5:1 to 2000:1, particularly preferably from 20:1 to 1000:1.

The present invention also provides a process as described above wherein the particle (P) which is solid at room temperature comprises at least one further component selected from fillers and/or fibrous materials (X), polymers (PM), and further additives (Z). The addition of these additional components can take place in any step of the production process for the solid particle (P), for example prior to or together with the addition of catalyst (K) and/or activator (A).

The solid particle (P) can comprise one or more polymers (PM). The solid particle (P) can by way of example comprise a polymer and/or oligomer which forms in situ via polymerization of the monomers comprised in the composition. The amount comprised of said polymer (PM) optionally comprised is by way of example from 0 to 40% by weight, preferably from 0 to 20% by weight, particularly preferably from 0 to 10% by weight.

The solid particle (P) can moreover comprise one or more polymers (PM) which are added in the form of a polymer to the composition. This added polymer can by way of example comprise groups which are suitable for the formation of block copolymers and/or graft copolymers with the polymer formed from the lactam monomer. Examples of these groups are epoxy, amine, carboxy, anhydride, oxazoline, carbodiimide, urethane, isocyanate, and lactam groups.

Another possibility for improving the properties of the product, the compatibilities of the component, and viscosity, is to add to the solid particle (P) at least one polymer (PM) selected from the group consisting of polystyrene, styrene copolymers, such as styrene-acrylonitrile copolymers (SAN), acrylonitrile-butadiene-styrene copolymers (ABS), or styrene-butadiene copolymers (SB), polyphenylene oxide ethers, polyolefins, such as polyethylene (HTPE (high-temperature polyethylene), LTPE (low-temperature polyethylene)), polypropylene, or poly-1-butene, polytetrafluoroethylene; polyesters, such as polyethyleneterephthalate (PET) or polyamides; polyethers, e.g. polyethylene glycol (PEG), or polypropylene glycol, or polyether sulfones (PESU or PES); polymers of monomers comprising vinyl groups, e.g. polyvinyl chloride, polyvinylidene chlorides, polystyrene, impact-modified polystyrene, polyvinylcarbazole, polyvinyl acetate, polyvinyl alcohol, polyisobutylene, polybutadiene, polysulfone, and copolymers of the polymers mentioned.

The solid particle (P) can moreover comprise a crosslinking monomer. A crosslinking monomer can be a compound which comprises more than one group which can be copolymerized with the lactam monomer. Examples of these groups are epoxy, amine, carboxy, anhydride, oxazoline, carbodiimide, urethane, isocyanate, and lactam groups. Examples of suitable crosslinking monomers are amino-substituted lactams, such as aminocaprolactam, aminopiperidone, aminopyrrolidone, aminolauryllactam, and mixtures of these, preferably aminocaprolactam, aminopyrrolidone, and mixtures of these, particularly preferably aminocaprolactam.

In one embodiment, the solid particle (P) comprises at least one filler and/or fibrous material (F). Organic or inorganic fillers and/or fibrous materials (F) can be used as filler and/or fibrous material (F). By way of example, it is possible to use inorganic fillers, such as kaolin, chalk, wollastonite, talc powder, calcium carbonate, silicates, titanium dioxide, zinc oxide, graphite, glass particles, e.g. glass beads, nanoscale filler, such as carbon nanotubes, carbon black, nanoscale phyllosilicates, nanoscale aluminum oxide (Al₂O₃), nanoscale titanium dioxide (TiO₂), graphene, phyllosilicates, and nanoscale silicon dioxide (SiO₂).

Preference is further given to the use of fibrous materials as filler and/or fibrous material (F). It is possible here to use one or more fibrous materials selected from known inorganic reinforcing fibers, such as boron fibers, glass fibers, carbon fibers, silica fibers, ceramic fibers, and basalt fibers; organic reinforcing fibers, such as aramid fibers, polyester fibers, nylon fibers, polyethylene fibers, and natural fibers, such as wood fibers, flax fibers, hemp fibers, and sisal fibers.

It is particularly preferable to use glass fibers, in particular chopped glass fibers, carbon fibers, aramid fibers, boron fibers, metal fibers, or potassium titanate fibers. The fibers mentioned can be used in the form of short fibers or long fibers, or in the form of a mixture of short and long fibers. The average fiber length of the short fibers here is preferably in the range from 0.1 to 1 mm. Preference is further given to fibers with an average fiber length in the range from 0.5 to 1 mm. The average fiber length of the long fibers used is preferably above 1 mm, with preference in the range from 1 to 50 mm.

In particular, it is also possible to use mixtures of the fillers and/or fibrous materials (F) mentioned. It is particularly preferable to select glass fibers and/or glass particles, in particular glass beads, as filler and/or fibrous material (F).

The solid particle (P) produced by the process described above preferably comprises from 30 to 90% by weight, in particular from 30 to 80% by weight, preferably from 30 to 50% by weight, more preferably from 50 to 90% by weight, of at least one filler and/or fibrous material (F).

In one preferred embodiment, the solid particle (P) can comprise further additives (Z). Preference is given to an amount of from 0 to 5% by weight of the additives (Z), a preferred amount being from 0 to 4% by weight, and a particularly preferred amount being from 0 to 3.5% by weight. Examples of additives (Z) that can be added are stabilizers, such as copper salts, dyes, antistatic agents, release agents, antioxidants, light stabilizers, PVC stabilizers, lubricants, flame retardants, blowing agents, impact modifiers, and nucleating agents.

It is preferable that the solid particle (P) comprises, as additive (Z), an impact modifier, in particular a polydiene polymer (e.g. polybutadiene, polyisoprene) comprising anhydride and/or epoxy groups. The glass transition temperature of the polydiene polymer is in particular below 0° C., preferably below −10° C., particularly preferably below −20° C. The polydiene polymer can be based on a polydiene copolymer with polyacrylates, with polyethylene acrylates, and/or with polysiloxanes, and can be produced by means of the familiar processes (e.g. emulsion polymerization, suspension polymerization, solution polymerization, or gas-phase polymerization).

Fillers and/or fibrous materials (F), and further additives (Z), can be added at any step of the production process for the solid particle (P), for example prior to or together with the addition of catalyst (K) and/or activator (A).

The present invention further provides a process for producing a polyamide molding, where a solid particle (P) obtainable via the process described above is polymerized via heating to a temperature of from 120° C. to 250° C.

It is generally advantageous to minimize the content of contaminants that can lead to termination of the anionic polymerization reaction, examples being water, carbon dioxide, and oxygen. All of the components used should therefore in particular be dry and free from oxygen and carbon dioxide. It is preferable that the polymerization reaction is carried out with substantial exclusion of oxygen, carbon dioxide, and water.

The present invention also provides a process for the production of a polyamide molding as stated above comprising the following steps:
melting and spraying of the solid particle (P) of the invention at a temperature of from 50° C. to 160° C.; in particular from 50° C. to 150° C., preferably from 50° C. to 100° C.;
charging of the molten, originally solid particle (P) to a mold cavity, or application of the powder to a textile, by means of an impregnation system;
polymerization of the particle (P) via heating to a temperature of from 120 to 250° C. by means of an injection-molding system, press, rotating mold cavity (rotomolding), flame spraying, powder coating, fluidized-bed sintering, or application on fibers or textiles and melting via infrared radiation or laser radiation.

The particle (P) which is solid at room temperature is preferably melted at a temperature greater than or equal to the melting point of the lactam monomer (L) used and at a temperature below 180° C., preferably below 160° C., particularly preferably below 120° C., very particularly preferably below 90° C.

The temperature range selected in step a) therefore depends on the selection of the lactam(s) (L).

The molten particle (P) can be charged to a mold cavity by means of a suitable shaping process (e.g. injection molding, casting process, etc.), and it can be polymerized there via temperature increase.

Preference is given to a process for the production of a polyamide molding as stated above where the mold cavity comprises at least one filler and/or fibrous material (F).

In one preferred embodiment, the mold cavity comprises a woven fiber material and/or a fiber network, for example a mat of glass fiber and/or a network of glass fiber.

It is moreover possible to charge a filler and/or fibrous material (F) together with the molten particle (P) to the mold cavity. Known processes (in an injection-molding apparatus or molding apparatus, for example) can be used for this. The optionally added filler and/or fibrous material (F) can be selected from the fillers and/or fibrous materials (F) mentioned above in connection with the process of the invention for the production of a solid particle (P).

The process of the invention can produce polyamide moldings with a high proportion of filler and/or of fibrous material. In particular, the invention provides a process as described above wherein the polyamide molding comprises a proportion in the range from 30 to 90% by weight, in particular from 30 to 80% by weight, preferably from 30 to 50% by weight, more preferably from 50 to 90% by weight, of a filler and/or fibrous material.

The present invention further provides the use of a particle (P) which is solid at room temperature and which is obtainable via a process as described above, for the production of a polyamide molding, in particular of a filled and/or fiber-reinforced molding. In particular, the proportion of filler and/or fibrous material in the polyamide molding is in the range from 30 to 90% by weight.

The polyamide moldings produced by the process of the invention can in particular be used as material for the production of components of automobile bodywork, e.g. passenger compartment or wheel surround, or else components of automobile parts, e.g. cladding of frames or dashboards, and components for the interior of passenger compartments. The polyamide moldings can also be used as inliners for tanks, gear wheels, housings, packaging films, and coatings.

In principle, the polyamide moldings produced by the process of the invention are suitable for any housing for small electrical devices such as mobile phones, laptops, iPads, or generally plastics items intended to imitate metal.

The solid particles (P) of the invention can also be used inter alia for laser sintering, rotomolding, and flame spraying.

The metering and mixing of the individual components in the process of the invention for the production of solid particles (P) takes place continuously, as also therefore does the production of the mixture. This leads to stationary-state process conditions with constant product properties and to a markedly higher operating time for the process when comparison is made with a batch process.

In the invention, the at least one lactam monomer (e.g. ε-caprolactam), at least one catalyst, and at least one activator are preferably provided separately from one another in the form of melt. All of the components are continuously conveyed and mixed.

The catalyst and the activator can respectively also take the form of a solution in the lactam monomer; it is important however that catalyst and activator are provided separately from one another.

In one embodiment of the invention, the activator is first admixed with the lactam stream, and the catalyst is then incorporated by mixing into said mixture. A mixture capable of reaction is produced only on addition of the catalyst. This mixture is by way of example converted to discrete droplets via spraying by way of a nozzle or by way of dropletization into a container to which cold inert gas is supplied (e.g. spray tower). As the droplets fall within the container, the mixture solidifies in droplet form. Reactive lactam particles are obtained at the outlet, and can undergo complete polymerization to give polyamide on exposure to heat.

In another embodiment of the invention, it is also possible to reverse the sequence of mixing to incorporate the activator and to incorporate the catalyst.

The materials provided and the feed lines have temperature-control, to a temperature above the melting point of the lactam (L) used. The gas temperature in the reactor is below the melting point of the lactam (L).

The conversion in the reaction prior to conversion to the droplet form can be adjusted to from 0 to 50%, preferably from 0 to 30%, particularly preferably from 0 to 10%, via the residence time between the mixing-incorporation point from which the mixture capable of reaction is present and the nozzle, and also by way of the temperature profile along the residence-time section.

In one preferred embodiment, the hardening process is carried out in apparatuses which are also suitable for the spray-drying process. Apparatuses of this type are described by way of example in K. Masters, Spray Drying Handbook, 5th edition, Longman, 1991, pp. 23-66.

In another preferred embodiment, the steps of mixing, of conversion of the mixture to droplet form, and of cooling are carried out in a prilling tower in the process of the invention.

The process of the invention for the production of solid particles (P) can use one or more spray nozzles. The spray nozzles that can be used are not subject to any restriction. The liquid to be sprayed can be introduced under pressure into these nozzles. The comminution of the liquid to be sprayed here can be caused by its depressurization after reaching a certain minimum velocity in the nozzle aperture. Single-fluid nozzles, such as slit nozzles, or centrifugal chambers (solid-cone nozzles) (for example from Düsen-Schlick GmbH, DE, or from Spraying Systems Deutschland GmbH, DE), can also be used for the purposes of the invention.

Throughput per spray nozzle is advantageously from 0.1 to 10 m³/h, frequently from 0.5 to 5 m³/h.

The process can also be carried out in apparatuses in which the reactive mixture can be subjected to free fall in the form of monodisperse droplets. Apparatuses such as those described in U.S. Pat. No. 5,269,980 are suitable for this purpose.

It is equally possible to produce droplets via laminar breakdown of a jet, as described in Rev. Sci. Instr. 38 (1967) 502.

However, the droplets can also be produced by means of pneumatic drawing dies, rotation, section of a jet, or rapid-response microvalve dies.

In a pneumatic drawing die, a jet of liquid is accelerated together with a gas stream through an aperture. The diameter of the jet of liquid, and thus the diameter of the droplets, can be influenced by way of the amount of gas used.

In the case of droplet production via rotation, the liquid passes through the openings in a rotating disk. The centrifugal force acting on the liquid disentrains droplets of defined size. Preferred apparatuses for rotation dropletization are described by way of example in DE 43 08 842 A1.

However, it is also possible to use a rotating blade to section the emerging jet of liquid into defined segments. Each segment then forms a droplet.

When microvalve dies are used, droplets are provided directly with defined liquid volume.

The average diameter of the discrete droplets produced is generally from 1 to 2000 μm, preferably from 10 to 1000 μm, particularly preferably from 50 to 500 μm, very particularly preferably from 100 to 200 μm, where the diameter of the droplets can be determined by light scattering, and is the volume-average diameter.

A gas can pass through the container. The carrier gas here can be conducted through the reaction space cocurrently or countercurrently with respect to the monomer mixture droplets that are in free fall, preferably cocurrently, i.e. downward. It is preferable that, after passage of the gas, it is at least to some extent returned to the reaction space, preferably to an extent of at least 50%, particularly preferably to an extent of at least 75%, in the form of a gas circuit. A portion of the carrier gas is usually discharged after each pass, preferably up to 10%, particularly preferably up to 3%, very particularly preferably up to 1%.

The oxygen content of the carrier gas is preferably at most 15% by volume, particularly preferably at most 5% by volume, very particularly preferably at most 0.1% by volume.

The carrier gas preferably comprises, alongside oxygen, an inert gas, particularly preferably nitrogen. The inert gas content of the carrier gas is preferably at least 80% by volume, particularly preferably at least 90% by volume, very particularly preferably at least 95% by volume.

The gas velocity is preferably adjusted in such a way that the flow in the reactor is oriented flow, where for example there are no convection vortices opposed to the general direction of flow, and this velocity is by way of example from 0.01 to 5 m/s, preferably from 0.02 to 4 m/s, particularly preferably from 0.05 to 3 m/s, very particularly preferably from 0.1 to 2 m/s.

The reaction can be carried out at superatmospheric pressure or at subatmospheric pressure, and preference is given to superatmospheric pressure which is up to 100 mbar above the ambient pressure.

The process of the invention for the production of polyamide via an anionic lactam polymerization reaction has numerous advantages. It can give simplified raw materials logistics, in particular simplified storage and simplified transport of the raw materials. The introduction of the raw materials into the process has been simplified.

The process of the invention for the production of polyamide via an activated anionic lactam polymerization reaction with use of the solid particles of the invention as raw material features logistical advantages, e.g. simple storage of the raw materials, simple transport of the raw materials, and simple introduction of the raw materials into the process.

The process of the invention for the production of polyamide via an activated anionic lactam polymerization reaction with the use of the solid particles of the invention as raw material is moreover characterized by the advantage that, within the prills themselves, it is possible to achieve exact adjustment of the stoichiometric ratio between lactam monomers and activator and, respectively, catalyst.

The particles of the invention which are solid at room temperature and which are made of lactam monomer, catalyst, and activator have numerous advantages. They are mechanically stable. They can be stored without undergoing chemical reaction or discoloring. The solid particles of the invention feature high stability of color and high stability in storage, and also high purity.

The process of the invention for the production of solid particles which comprise lactam, activator, and catalyst has numerous advantages. It is a simple method of providing solid particles of the stated constitution which are mechanically stable, can be stored, and are of pale color. The amount of apparatus needed is less than when lactam, activator, and catalyst are prepared separately.

The solid particles of the invention can have any desired size and shape. It is preferable that they are spherical or almost spherical (being known as prills). However, they can also have the shape of powder particles, flakes, or what are known as pellets.

The process of the invention for the production of solid particles which comprise lactam, catalyst, and activator is one wherein a mixture which comprises at least one lactam, at least one catalyst, and at least one activator is cooled and thus hardened. In one embodiment, this process is preferably conducted as what is known as a prilling process, i.e. the mixture is dispersed in the gas phase, for example in the form of spherical melt particles, and these then cool in free fall in the gas phase, and harden. The hardening preferably means crystallization.

However, it can also generally mean crystallization or solidification in the manner of a glass, giving the solid particles in an amorphous state.

The preferred conduct described in the invention for the process for the production of solid particles by way of the prilling process has the advantage that the prilling process can give a short residence time of the combined streams of material made of lactam, catalyst, and activator in the mixture. This occurs because the combined mixture made of lactam, catalyst, and activator can be rapidly cooled and hardened in the prilling process. A resultant advantage of this is that the individual components lactam, catalyst, and activator do not react with one another in the mixture, or do not react completely with one another in the mixture, and it is thus possible to control the conversion within the particles. The advantage mentioned is a feature of the prilling process in comparison with other processes for hardening a mixture, for example processes for producing granules or flakes.

Accordingly, one particularly preferred embodiment of the process of the invention for the production of solid particles conducts the process as a prilling process where the process has only short residence times of the combined mixture made of lactam, catalyst, and activator, and where the temperature of the combined mixture made of lactam, catalyst, and activator is only slightly above the hardening point of said mixture.

The residence time of the combined mixture made of lactam, catalyst, and activator is preferably less than 60 seconds, particularly preferably less than 30 seconds, and very particularly preferably less than 10 seconds. The temperature of the combined mixture made of lactam, catalyst, and activator is preferably less than 20° C. above the hardening point of said mixture, particularly preferably being less than 5° C. above the hardening point, and very particularly preferably less than 1° C. above the hardening point of said mixture.

One particularly preferred embodiment of the process of the invention is accordingly one which provides the separate melts made of lactam, catalyst, and activator respectively separately at a temperature just above the melting point thereof, and then mixes them, and then cools them to a temperature just above the hardening point of the mixed melt, and then hardens them in a prilling process, where the conduct of the entire process is such that the residence time of the combined melt made of lactam, catalyst, and activator in the liquid phase, i.e. up to hardening via prill production, is minimized.

An equally preferred embodiment of the process of the invention for the production of the solid particles is the hardening of the melt which comprises lactam, catalyst, and activator to give granules or flakes by known processes.

An equally preferred embodiment of the process of the invention for the production of the solid particles is the pelletization of a melt which comprises lactam, catalyst, and activator, by known pelletization processes.

In one preferred embodiment, the solid particles are composed of at least one lactam, of at least one activator, and of at least one catalyst, but comprise no other substances. It is of course known to the person skilled in the art here that small amounts of contaminants can remain comprised in the solid particles. These are therefore not covered by the wording “other substances”, the meaning of which is simply that the solid particles do not intentionally comprise other substances to any significant extent; the meaning here may cover, for example, antiflow additives, fillers, or any other desired substances.

The examples below provide further explanation of the invention. These examples illustrate some aspects of the present invention but are in no way to be considered to have any restricting effect on the scope of protection of this invention.

### EXAMPLE 1

ε-Caprolactam at 85° C. with a conveying rate of 8.44 kg/h is mixed in a static mixer continuously with a solution composed of 95.2 percent by weight of ε-caprolactam and 4.8 percent by weight of sodium caprolactamate, this solution being added at a conveying rate of 4.25 kg/h. The temperature of the mixture is controlled to 80° C. After continuous addition of 0.55 kg/h of a solution composed of 80 percent by weight of N,N′-hexamethylenebis(carbamoyl-ε-caprolactam) and 20 percent by weight of caprolactam, the resultant mixture is sprayed by means of a two-fluid nozzle into a spray tower (also termed prilling tower) inertized with nitrogen. The temperature of the gas phase in the spray tower is 25° C. Particles with an average size of 160 μm are obtained.

One week later, the resultant powder is injection-molded in an Arburg 270 S injection-molding machine with vertical injection unit, at a product temperature of 80° C. The cylinder temperature profile was 60/65/70/75° C., injection time 0.8 s, hold pressure time 2 s. The melt is injected into a mold heated to 150° C. The polymerization reaction is then allowed to proceed for 5 minutes. The resultant polyamide molding is removed from the mold.

The content of residual monomer (caprolactam) in the polyamide product is determined chromatographically. The intrinsic viscosity of the polyamide product is determined to ISO 307 at 5° C. in 96% sulfuric acid. The polymer obtained comprises 1.1% by weight of residual caprolactam, and its intrinsic viscosity is 320.

### EXAMPLE 2

The solid monomer composition produced in example 1 is stored for one month. The polymerization reaction is then conducted as described in example 1. The residual monomer content of the polyamide obtained is 1.15% by weight of caprolactam, and its intrinsic viscosity is 305.

It can therefore be shown that the monomer compositions produced by means of the process of the invention are stable over a long period, i.e. can still be polymerized to completion even after a long time.

### EXAMPLE 3

ε-Caprolactam at 85° C. with a conveying rate of 8.44 kg/h is mixed in a static mixer continuously with a solution composed of 95.2 percent by weight of ε-caprolactam and 4.8 percent by weight of sodium caprolactamate, this solution being added at a conveying rate of 4.25 kg/h. The temperature of the mixture is controlled to 80° C. After continuous addition of 0.55 kg/h of a solution composed of 80 percent by weight of N,N′-hexamethylenebis(carbamoyl-ε-caprolactam) and 20 percent by weight of caprolactam, the resultant mixture is sprayed by means of a two-fluid nozzle into a spray tower inertized with nitrogen. The temperature of the gas phase in the spray tower is 30° C. Particles with an average size of 160 μm are obtained.

One week later, the resultant caprolactam powder is injection-molded in an Arburg 270 S injection-molding machine with vertical injection unit, at a product temperature of 80° C. The cylinder temperature profile was 60/65/70/75° C., injection time 0.8 s, hold pressure time 2 s. The melt is injected into a mold heated to 150° C. The polymerization reaction is then allowed to proceed for 5 minutes. The resultant polyamide molding is removed from the mold.

The content of residual monomer (caprolactam) in the polyamide product is determined chromatographically. The intrinsic viscosity of the polyamide product is determined to ISO 307 at 5° C. in 96% sulfuric acid. The polymer obtained comprises 1.1% by weight of residual caprolactam, and its intrinsic viscosity is 320.

### EXAMPLE 4

ε-Caprolactam at 85° C. with a conveying rate of 8.44 kg/h is mixed in a static mixer continuously with a solution composed of 95.2 percent by weight of ε-caprolactam and 4.8 percent by weight of sodium caprolactamate, this solution being added at a conveying rate of 4.25 kg/h. The temperature of the mixture is controlled to 80° C. After continuous addition of 0.55 kg/h of a solution composed of 80 percent by weight of N,N′-hexamethylenebis(carbamoyl-ε-caprolactam) and 20 percent by weight of caprolactam, the resultant mixture is sprayed by means of a two-fluid nozzle into a spray tower inertized with nitrogen. The temperature of the gas phase in the spray tower is 25° C. Caprolactam particles with an average size of 160 μm are obtained.

One week later, the caprolactam powder thus obtained is applied at a product temperature of 23° C. to a glass fiber mat, the proportion by volume being 50%. A twin-belt press is used to press the composite at 150° C., and the residence time of the composite in the press here is 3 min. The polyamide molding obtained was removed from the mold.

The content of residual monomer (caprolactam) in the polyamide product was determined chromatographically. The intrinsic viscosity of the polyamide product was determined to ISO 307 at 5° C. in 96% sulfuric acid. The polymer obtained comprised 1.3% by weight of residual caprolactam, and its intrinsic viscosity was 290.

1-6. (canceled)

7. A process for producing solid particles, the process comprising:
mixing at least one lactam monomer, at least one activator, at least one catalyst and optionally a further component to form a mixture, wherein the mixing is performed at a temperature in the range from the melting point of the highest-melting-point lactam monomer in the mixture to 50° C. above the melting point of the highest-melting-point lactam monomer in the mixture;
converting the mixture to droplet form;
cooling the droplet to a temperature in the range from 100° C. below the melting point of the mixture to 10° C. below the melting point of the mixture, to obtain a cooled mixture; and
optionally granulating the cooled mixture,
to obtain solid particles comprising 50 to 99.7 parts by weight of the lactam monomer, 0.2 to 8 parts by weight of the activator, and 0.1 to 3.6 parts by weight of the catalyst, wherein a volume-average diameter of the particles is in the range from 1 to 2000 μm.

8. The process of claim 7, where the conversion in the reaction prior to the conversion to droplet form is from 0 to 50%.

9. The process of claim 7, where the cooling of the droplet takes place within a period in the range from one millisecond to ten minutes.

10. The process of claim 7, where the cooling of the droplet takes place within a period in the range from one millisecond to one minute.

11-14. (canceled)

15. The process of claim 7, comprising granulating the cooled mixture.

16. The process of claim 7, wherein the particles obtained have a volume-average diameter of 10 to 1000 μm.

17. The process of claim 7, wherein the particles obtained have a volume-average diameter of 50 to 500 μm.

18. The process of claim 7, wherein the particles obtained have a volume-average diameter of 100 to 200 μm.

19. The process of claim 7, wherein the lactam monomer is at least one member selected from the group consisting of caprolactam, piperidone, pyrrolidone, and lauryllactam.

20. The process of claim 7, wherein the catalyst is at least one member selected from the group consisting of sodium caprolactamate, potassium caprolactamate, magnesium bromide caprolactamate, magnesium chloride caprolactamate, magnesium biscaprolactamate, sodium hydride, sodium, sodium hydroxide, sodium ethanolate, sodium methanolate, sodium propanolate, sodium butanolate, potassium hydride, potassium, potassium hydroxide, potassium methanolate, potassium ethanolate, potassium propanolate, and potassium butanolate.

21. The process of claim 7, wherein the activator is at least one member selected from the group consisting of hexamethylene diisocyanate, isophorone diisocyanate, hexamethylenedioyl bromide, and hexamethylenedioyl chloride.

22. The process of claim 8, where the cooling of the droplet takes place within a period in the range from one millisecond to ten minutes.

23. The process of claim 8, where the cooling of the droplet takes place within a period in the range from one millisecond to one minute.
